(19) United States
(12) Patent Application Publication
(10) Pub. No.: US 2008/0073940 A1
(43) Pub. Date: Mar. 27, 2008

(54) Vehicle with Openable Roof Structure

(75) Inventor: Winfried Bunsmann, Bissendorf (DE)

Correspondence Address: MICHAEL BEST & FRIEDRICH LLP, 100 E WISCONSIN AVENUE, Suite 3300, MILWAUKEE, WI, 53202, US

(73) Assignee: WILHELM KARMANN GMBH, 49084 OSNABRUCK GERMANY (DE)

(21) Appl. No.: 11/664,240

(22) PCT Filed: Sep. 23, 2005
(86) PCT No.: PCT/DE05/01681

§ 371 Date: Mar. 29, 2007

(30) Foreign Application Priority Data
Oct. 2, 2004 (DE) 10-2004-048-123.7

(51) Int. Cl. B60J 7/02

(52) U.S. Cl. 296/203.03

(57) ABSTRACT

A roof structure for a sun roof system includes a roof frame extending at least between an A-pillar and a rear structural pillar of a vehicle. At least one roof element of the roof system is movably guided in or on the roof frame substantially in the vehicle longitudinal direction between a closed roof position and an opened roof position. The roof element is rotatable relative to the roof frame and is lowerable along the structural pillar. The structural pillar is inwardly offset relative to an outer shell of the vehicle, so that the outer shell is completely formed without contacting the structural pillar.

The invention relates to a roof structure, in which a sun roof system for a motor vehicle is physically integrated.

The invention particularly concerns a vehicle with a roof frame, which extends from a forward structural pillar of a vehicle, normally the A-pillar, to a rearward structural pillar of a vehicle, such as e.g., the B- or C-pillar, on both sides of the vehicle roof, each side having at least one roof strut, wherein roof elements, e.g., plate elements, are displaceably guided between the two roof struts extending substantially in the vehicle longitudinal direction, so that they can be moved in the vehicle longitudinal direction. The roof elements are, in particular, movable between a closed roof position of the vehicle roof, in which they close the opening between the roof struts, and an opened position, in which the opening between the roof struts is open. The roof elements are lowered into the opened position along pillars or guides especially provided therefor, which pillars or guides extend from the roof struts towards the vehicle floor in the rear area of the vehicle. During this process, the roof struts remain stationary and when the roof is opened, the roof struts delimit the upper portion of the passenger compartment.

A vehicle roof of the above-described type is illustrated in DE 296 22 436 U1. In this reference, three rigid plate elements are pivotable about a vehicle transverse axis and are displaceable in the vehicle longitudinal direction. After they are brought into the vehicle rear area by displacing them, the opening of the vehicle roof is completed by lowering the vehicle roof elements, which are folded or laid on each other, into the rear space.

Due to the provision of pillar-like guides for the lowering movement of the roof elements in addition to the structural pillars of the vehicle, an impairment of the view for the driver or the passengers often results, because additional pillars are perpendicularly provided in the passenger compartment underneath the roof struts, which roof struts are inwardly offset relative to the vehicle body. Moreover, these pillars can interfere with design considerations.

It is an object of the present invention to improve the view for the driver when using a conventional roof system.

This object is achieved by a roof structure having the features of claim 1. Preferred embodiments are provided in the dependent claims.

The concept underlying the invention is, when using a conventional roof system, to concurrently utilize the rearward structural pillars, i.e. the B-pillar and/or the C-pillar, of the motor vehicle as guide pillars for the linear guidance of the rigid or foldable roof elements. By inwardly offsetting the structural pillars, i.e. away from the outer shell of the vehicle, so that the structural pillars are not physically integrated into the outer shell of the vehicle, a space for viewing for the driver can be provided between the outer shell of the vehicle and the structural pillar. Moreover, the side outer shell of the vehicle can be constructed as completely transparent in the upper vehicle area, i.e. each area that is bounded by the floor-side vehicle structure, the A-pillar, the B-pillar or C-pillar and each roof strut of the vehicle. Thus, the lateral view towards the outside is likewise improved.

In the following, the invention will be described in an exemplary manner with the assistance of the appended figures, in which:

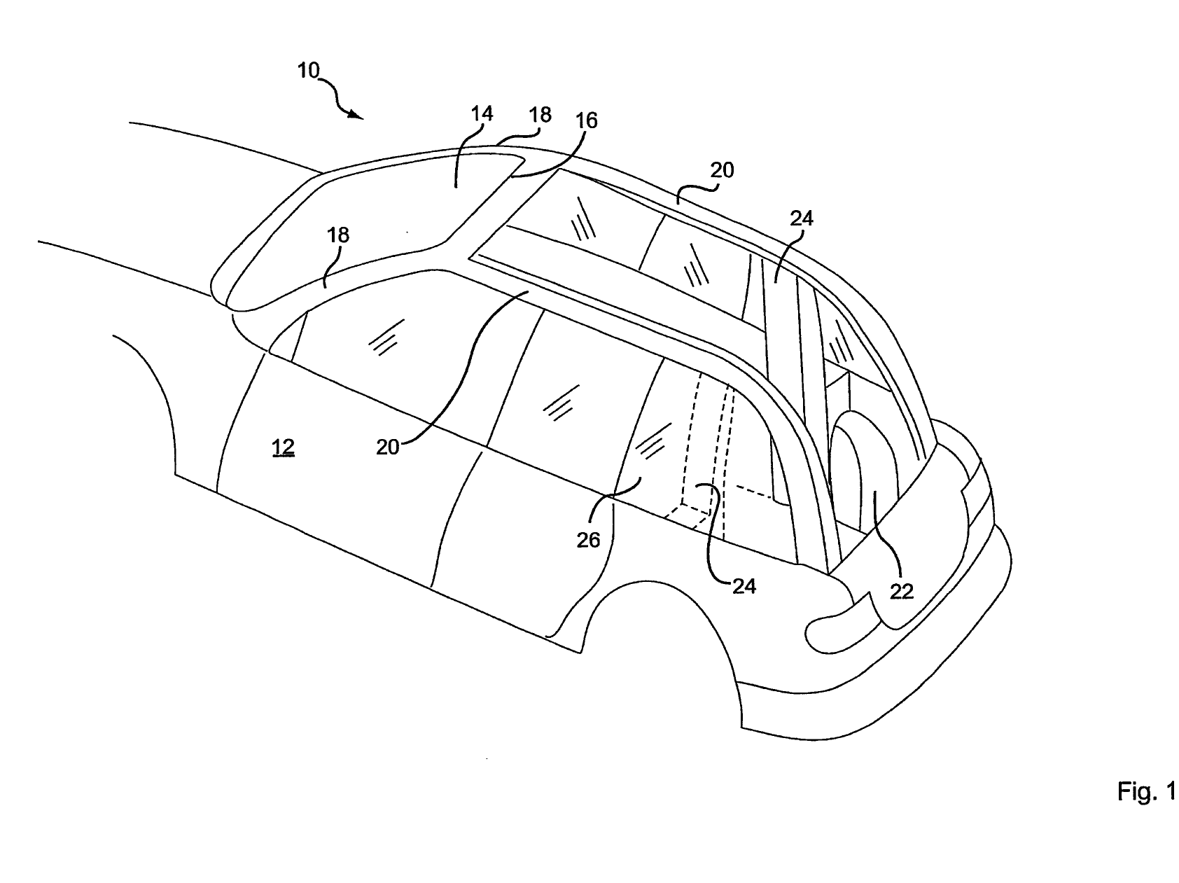

FIG. 1 shows a perspective view of an inventive roof system;

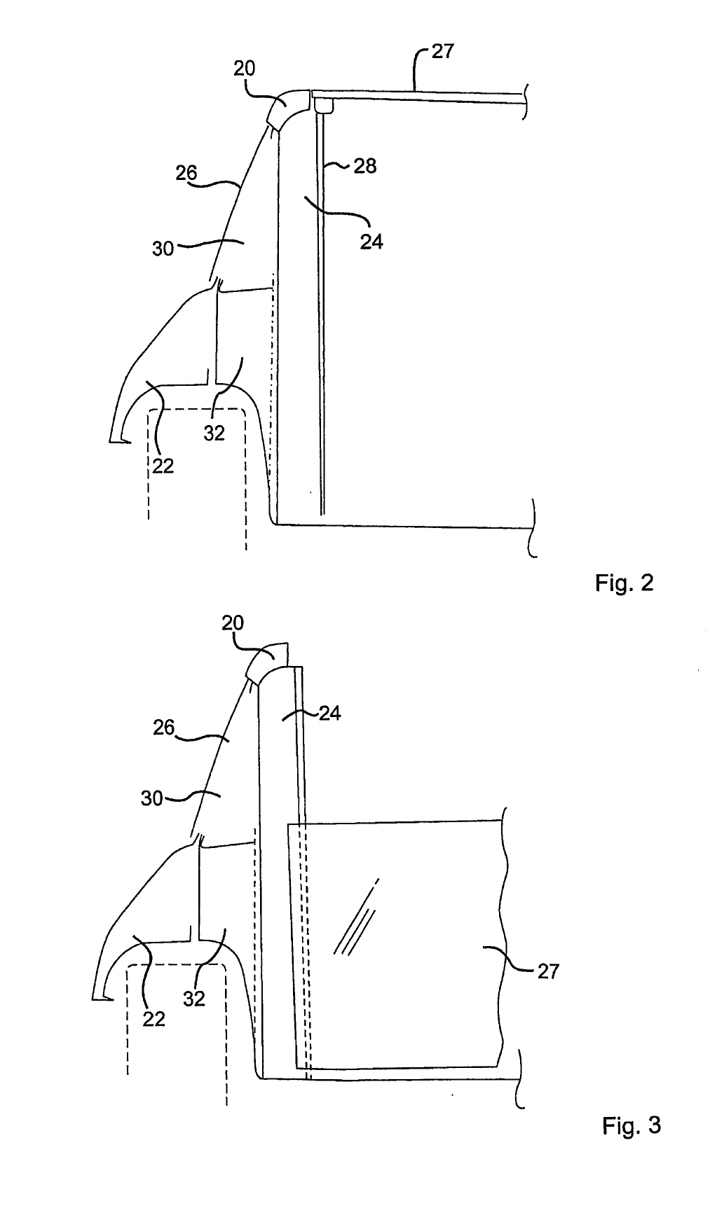

FIG. 2 shows a cross-sectional view in the area of a rear structural pillar for the roof structure according to FIG. 1, wherein the roof system is in the closed position; and

FIG. 3 is a cross-sectional view like FIG. 2, wherein the roof system, however, is in the opened position.

FIG. 1 shows a perspective view of a roof portion 10 for a motor vehicle. A vehicle structure 12 (not shown in FIG. 1) adjoins the roof portion 10 from below. The part of the vehicle body and of the structure elements of the vehicle, which part lies under the side- and rear-windows and/or the front windshield 14, is designated by vehicle structure 12.

In the forward area of the vehicle, the roof portion 10 includes a front window 14, which is bordered by a windshield frame 16 as well as two A-pillars 18 that extend from the front hood to the roof. Lateral struts 20 extend substantially in the vehicle longitudinal direction between the windshield frame 16 and the vehicle rear end. The struts 20 are stationary and, when opening the vehicle roof, are not moved therewith. The struts 20 extend rearward from their connection point on the A-pillar 18 initially substantially parallel to a vehicle floor and then proceed downward to the vehicle rear end, so that they join to the vehicle structure 12 there.

Approximately in the area of the wheel houses 22 in the vehicle longitudinal direction, the C-pillars 24 are disposed as additional structural pillars between the roof struts 20 and the vehicle structure 12. The C-pillars 24 are connected with the roof struts 20 and downwardly extend substantially perpendicular from these struts 20. The C-pillars 24 are inwardly offset relative to the outer shell 26 of the vehicle and do not form a part of the outer shell 26. The side windows are not separated by structural pillars. The C-pillars 24 include linear guides 28 indicated in FIGS. 2 and 3; rigid plate elements 27, which form the openable part of the roof system, can be lowered, after a pivoting movement about an axis extending substantially in the vehicle transverse direction, along the linear guides 28 into the vehicle rear floor area.

If necessary, a not-illustrated mechanism for moving the plate elements 27 can be integrated in the C-pillars 24 near the guide 28.

The outer shell 26 extends outward and downward at an incline from the roof struts 20 to the vehicle body shell, in particular to the wheel house 22 and to its mid-region (see FIGS. 2 and 3), so that a clearance 30 is provided between the structural pillars 24, which undertake the guidance of the roof elements 27, and the outer shell 26 of the vehicle. The structural pillars 24, in particular the C-pillars 24, are connected with the vehicle body shell via substantially horizontally extending connection brackets 32 at the top of the vehicle body shell, i.e. underneath the side windows, for bridging the gap between the structural pillars and the vehicle body shell.

The outer shell 26 is preferably in the form of a plurality of sheets of glass, so that it is transparent. In this case, a view for the driver laterally and rearward on both sides of the vehicle is possible over nearly the entire length of the vehicle.

Instead of using rigid plate elements 27 for the roof structure, fabric elements or a retractable textile roof construction, which is/are displaceable along the structural pillars 24 and the top frame 20, can also be utilized.

In FIGS. 2 and 3, the opening procedure for the roof system is illustrated. From the closed position of the roof shown in FIG. 2, in which the roof plates 27 assume a substantially horizontal position between the roof struts 20 laying side-by-side along the vehicle longitudinal direction of the vehicle, the plate elements 27 are each pivoted, preferably at the beginning of the opening procedure, about an axis extending substantially in the vehicle transverse direction for opening the roof, so that they are ultimately in a vertical position and are substantially parallel to each other. Then, they are displaced along the vehicle longitudinal direction in guides on or in the roof struts 20 into a state rotated from the closed position and are brought close to each other. Upon arriving at the C-pillars 24, the plate elements 27 stacked on each other can be displaced in the vertical direction along the guides 28 of the C-pillars 24, as shown in FIG. 3. In this case, they can be loaded into the vehicle rear area. For folding roof constructions between the roof struts, the roof elements can be initially displaced in the vehicle longitudinal direction for opening and then can be folded in an accordion-like manner. The folded roof is then lowered along the structural pillars in a corresponding manner.

Preferably, the roof plate elements 27 are also transparent. According to the respective opening requirements of the roof elements, special considerations in the vehicle rear area and design aspects, a plurality of roof plate elements, e.g., 3 or 4 rigid elements, are preferably provided, which rigid elements are displaceable in the vehicle longitudinal direction in the above-described manner and are loadable into the vehicle rear area along the guides of the C-pillars 24. The number of roof elements is freely selectable in accordance with design requirements, wherein the use of only one roof element is also possible. For closing the roof from the position shown in FIG. 3, the described steps are carried out in the reverse order and direction.

The essential aspect of the invention lies in that, for the guidance of roof elements, it is possible to dispense with a second pillar or a guide element adjacent to the C-pillar (in addition or in the alternative to the B-pillar). Thus, according to the invention, it is not necessary to provide an additional lattice-parallel pillar.

### REFERENCE NUMBERS

10 Roof portion
12 Vehicle structure
16 Windshield frame
18 A-pillar
20 Roof strut
22 Wheel house
24 C-pillar
26 Outer shell
28 Guide
30 Clearance
32 Connection bracket

1-9. (canceled)

10. A vehicle comprising:
a roof frame extending in a longitudinal direction of the vehicle at least between a first structural pillar adjoining a windshield and a second structural pillar disposed rearward of the first structural pillar,
an outer shell disposed in a vertical direction of the vehicle between the roof frame and a vehicle body, and
at least one roof element guidably movable in or on the roof frame substantially in the vehicle longitudinal direction between a closed roof position and an opened roof position, the at least one roof element also being guidably lowerable along the second structural pillar and
the second structural pillar is inwardly offset relative to the outer shell, such that the outer shell does not contact the second structural pillar.

11. A vehicle according to claim 10, wherein the outer shell is transparent.

12. A vehicle according to claim 10, wherein the second structural pillar is connected to the roof frame, at least an inner side of the second structural pillar extends downward substantially perpendicular from the roof frame and the outer shell extends downward from the roof frame at an incline, such that a clearance is defined between the outer shell and the second structural pillar.

13. A vehicle according to claim 12, wherein at least a portion of the outer shell that is adjacent to the second structural pillar is transparent.

14. A vehicle according to claim 13, wherein the second structural pillar is a B-pillar or a C-pillar of the vehicle.

15. A vehicle according to claim 14, further comprising a bracket connecting the vehicle body to the second structural pillar, the bracket being disposed completely below the outer shell.

16. A vehicle according to claim 15, wherein the outer shell extends in the vehicle longitudinal direction between the first structural pillar and a vehicle body structural element that is disposed rearward of the second structural pillar.

17. A vehicle according to claim 10, wherein at least two roof elements are rotatable relative to the roof frame and are lowerable along the second structural pillar in a folded-together state.

18. A vehicle according to claim 17, wherein the roof elements are plate elements.

19. A vehicle according to claim 10, wherein the at least one roof element is a retractable textile roof element.

20. A vehicle according to claim 10, wherein the outer shell comprises at least one side window of the vehicle.

21. A vehicle according to claim 10, wherein the outer shell comprises at least one side window that extends from the roof frame at an incline to a vertical direction of the vehicle, the second structural pillar is connected to the roof frame and extends downward substantially perpendicular from the roof frame, such that a clearance is defined between the at least one side window and the second structural pillar, and wherein a bracket connects the vehicle body to the second structural pillar, the bracket being disposed completely below the outer shell.

22. A vehicle according to claim 21, wherein the first structural pillar is the A-pillar of the vehicle and the second structural pillar is the B-pillar or the C-pillar of the vehicle.

23. A vehicle according to claim 22, wherein the outer shell extends in the vehicle longitudinal direction between the A-pillar and a rear end of the vehicle.

24. A vehicle comprising:
a roof strut extending in a longitudinal direction of the vehicle from an A-pillar adjoining a windshield to at least a second structural pillar disposed rearward of the first structural pillar, wherein the second structural pillar is one of a B-pillar and a C-pillar of the vehicle, the second structural pillar supports the roof strut and at least an inwardly facing side of the second structural pillar extends downward substantially perpendicular to the roof strut,
a side window disposed adjacent to the second structural pillar and between the roof strut and a vehicle body, wherein the second structural pillar is inwardly offset relative to the side window, such that the side window does not contact the second structural pillar and a clearance is defined between the side window and the second structural pillar, and
at least one roof element guidably movable in or on the roof strut substantially in the vehicle longitudinal direction between a closed roof position and an opened roof position, wherein the at least one roof element is also guidably lowerable along the second structural pillar to and from a storage position provided in a rear portion of the vehicle.

25. A vehicle according to claim 24, wherein the side window extends from the roof strut at an incline to the second structural pillar.

26. A vehicle according to claim 24, further comprising a bracket connecting the vehicle body to the second structural pillar, the bracket being disposed completely below the at least one side window.

27. A vehicle according to claim 24, wherein at least two rigid roof elements are rotatable relative to the roof strut so as to be folded together and are lowerable along the second structural pillar in the folded together state.

28. A vehicle according to claim 24, wherein the at least one roof element is a retractable textile roof element.

29. A vehicle according to claim 24, wherein the roof strut extends substantially to a rear end of the vehicle and the roof strut downwardly curves between the second structural pillar and the vehicle rear end.
